(19) United States
(12) Patent Application Publication
(10) Pub. No.: US 2018/0049029 A1
(43) Pub. Date: Feb. 15, 2018

(54) INTELLIGENT REMOTE TOUCH FOR TOUCH SCREEN DEVICES

(71) Applicant: QUALCOMM Incorporated, San Diego, CA (US)

(72) Inventors: Akash KUMAR, Hyderabad (IN); Niranjan Kumar VADLAMUDI, Hyderabad (IN); Ankit MAHESHWARI, Hyderabad (IN)

(21) Appl. No.: 15/234,992

(22) Filed: Aug. 11, 2016

(51) Int. Cl. H04W 12/08; G06F 21/36; H04L 29/06; H04W 12/06; G06F 3/0488

(52) U.S. Cl. CPC H04W 12/08; H04W 12/06; G06F 3/0488; H04L 63/102; G06F 21/36

(57) ABSTRACT

An intelligent remote touch mechanism is provided. In one aspect, a device with a touch screen initiates remote wireless access of the device by a remote device by receiving a remote access command without using its touch screen. The device authorizes remote wireless access by the remote device based on an authorization code received from the remote device. The device may receive a remote command from the remote device. In another aspect, a device receives a notification regarding the availability of remote wireless access to a touch screen device. The device transmits an authorization code to the touch screen device. The device receives a confirmation that remote wireless access to the touch screen device is enabled. The device receives, by its touch screen, a command for performing a function at the device. The device transmits the command wirelessly to the touch screen device.

### BACKGROUND

### Field

The present disclosure relates generally to remote access of electronic devices and systems, and more particularly, to intelligent remote touch for touch screen devices.

### Background

Touch screen devices are information processing systems equipped with touch screens. A touch screen may be an input device layered on the top of an electronic visual display of an information processing system. The information processing system may receive input or be controlled through simple or multi-touch gestures received by the touch screen. The user can use the touch screen to react to what is displayed and to control how user interface items are displayed; for example, zooming to increase the text size. The touch screen enables the user to interact directly with what is displayed, rather than using a mouse, touchpad, or any other intermediate device. Touch screen devices may include game consoles, personal computers, tablet computers, electronic voting machines, and smartphones.

There are scenarios where the touch screen of a touch screen device cannot be used and hence device control may not be possible through the touch screen. For example, the touch screen of a touch screen device may be broken, may be frozen, or may suffer some other form of damage that prevents commands being sent to the device from the touch screen. In another example, the battery charge of the touch screen device may be low, and use of the device without using the touch screen may be desirable to extend battery life when the device operates on battery power. In yet another example a person may need to make a call using a second person's phone. A security threat and/or a privacy threat may occur to the second person when the second person's phone is manually borrowed by the person. In yet another example, if the passcode is incorrectly entered a certain number of times in a row, e.g., because the unlock code/pattern is forgotten or because a family member enters the wrong unlock code multiple times, the touch screen device may be locked until the phone is reset by the manufacturer. The scenarios described above may render the touch screen device useless or may pose a security risk and/or privacy risk to the touch screen device.

### SUMMARY

The following presents a simplified summary of one or more aspects in order to provide a basic understanding of such aspects. The summary is not an extensive overview of all contemplated aspects, and is intended to neither identify key or critical elements of all aspects nor delineate the scope of any or all aspects. The sole purpose of the summary is to present some concepts of one or more aspects in a simplified form as a prelude to the more detailed description that is presented later.

In cases where the touch screen of a device is damaged or if for some other reason the touch screen is not working, there may be no way of controlling and giving commands to the touch screen device. In an aspect of the disclosure, an intelligent remote touch mechanism is provided. The intelligent remote touch mechanism enables commands to be provided to the touch screen device without using the device's touch screen when the touch screen is not in working condition, when the touch screen is turned off to extend battery life, or for convenience of use etc. In one configuration, the touch screen device to be controlled remotely without physical touch may be paired with another device, which then may be used to control the touch screen device (e.g., give commands to the touch screen device).

In an aspect of the disclosure, a method, a computer-readable medium, and an apparatus are provided. The apparatus may be a touch screen device. The apparatus may initiate remote wireless access of the apparatus by a remote device by receiving a remote access command on the apparatus without using the touch screen of the apparatus. The apparatus may authorize the remote wireless access by the remote device without using the touch screen of the apparatus based on an authorization code received from the remote device. The apparatus may receive a remote command from the remote device.

In another aspect of the disclosure, a method, a computer-readable medium, and an apparatus are provided. The apparatus receives a notification from a touch screen device regarding the availability of remote wireless access to the touch screen device. The apparatus transmits an authorization code to the touch screen device. The apparatus may receive a confirmation that the remote wireless access to the touch screen device is enabled. The apparatus receives a command for performing a function at the apparatus. The apparatus transmits the command wirelessly to the touch screen device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a touch screen device.

FIG. 2 depicts diagrams illustrating an example of intelligent remote touch for a touch screen device.

FIG. 3 is a flowchart of a method of wireless remote touch.

FIG. 4 is a flowchart of a method of wireless remote touch.

FIG. 5 is a conceptual data flow diagram illustrating the data flow between different means/components in an exemplary apparatus.

FIG. 6 is a diagram illustrating an example of a hardware implementation for an apparatus employing a processing system.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of electronic devices and systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

When the touch screen of a device is damaged, broken or for some other reason the touch screen is not working, there may be no mechanism in place to operate the touch screen device. In such a scenario, there may be a need to access to the touch screen device before repairing the touch screen. For example, contact details stored in the device may need to be accessed. In another example, making a call without having to remove the sim card physically from the touch screen phone and putting the sim card into another device may be desirable. In yet another example, access to the wireless network to download some files, sync emails, etc. may be desirable using the damaged touch screen device.

In an aspect, the damaged touch screen device may be paired with another device to allow the damaged touch screen device to be remotely controlled from the other device. By allowing the damaged touch screen device to be operated remotely, the damaged touch screen device may remain fully functional before the touch screen is repaired or replaced. Additionally, the remote access feature may be enabled without a functional touch screen in the device.

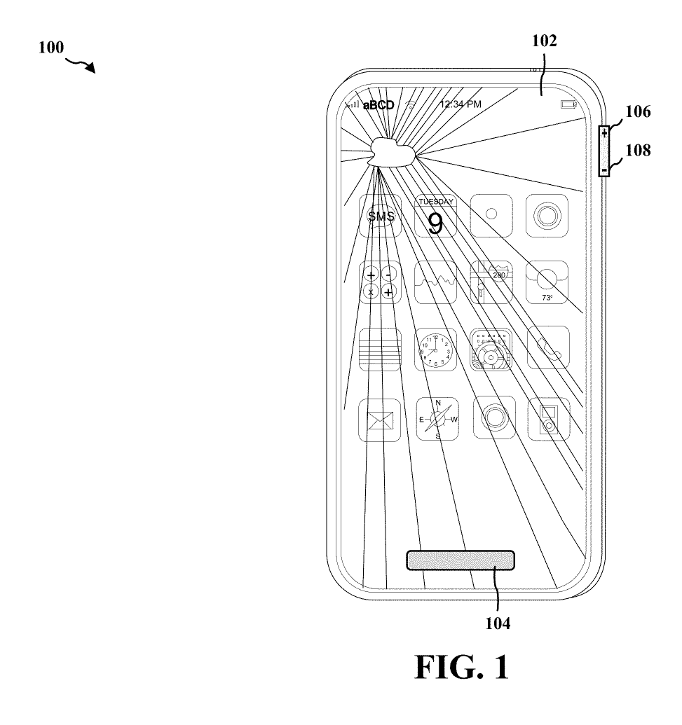

FIG. 1 is a diagram illustrating an example of a touch screen device 100. The touch screen device 100 may be a smartphone, a tablet computer, or any other device that is equipped with a touch screen. As illustrated, the touch screen device 100 includes a touch screen 102, a power on/off button 104, a volume up button 106, and a volume down button 108.

The touch screen 102 may be broken (as illustrated), otherwise prevented from being used or preferred not to be used. The unavailability of touch screen 102 may prevent the touch screen device 100 from receiving inputs from the touch screen rendering the touch screen device 100 unusable. In an aspect, a fixed pre-defined pattern of pressing existing buttons (e.g., pushing one or more of the power on/off button 104, the volume up button 106, the volume down button 108) may be used to turn on the device's Bluetooth or Wi-Fi and enable remote access of the touch screen device 100. Thus, even though the touch screen device's touch screen 102 is not working, the remote access feature of the device may still be enabled.

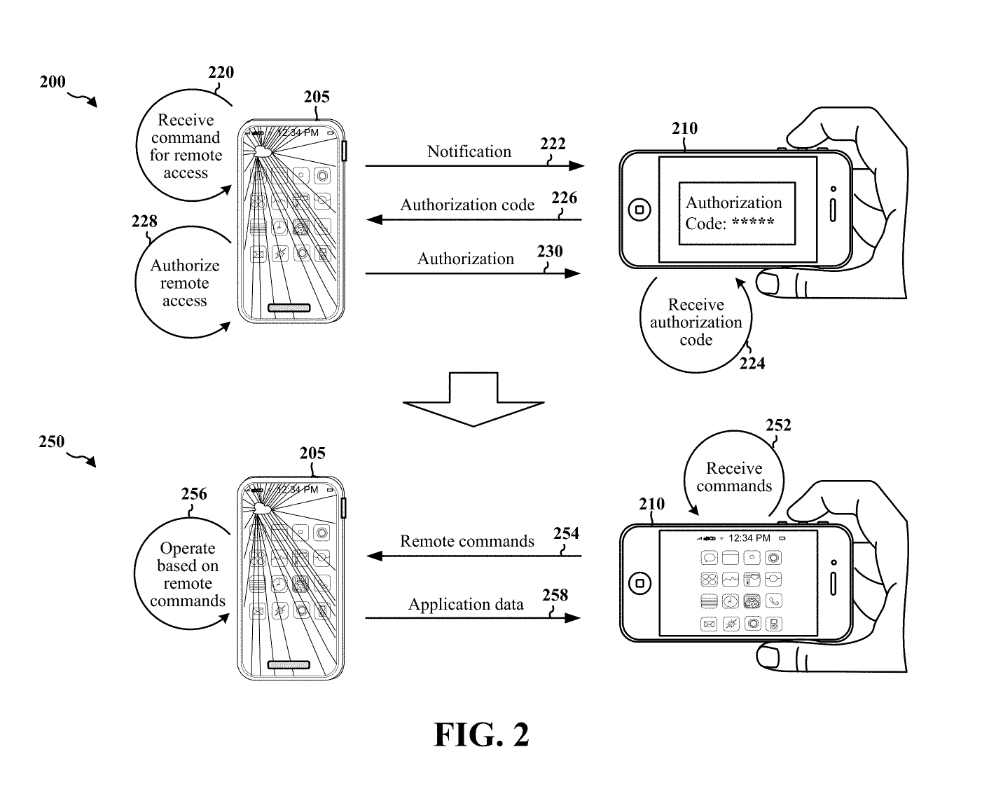

FIG. 2 depicts diagrams 200 and 250 illustrating an example of intelligent remote touch for a touch screen device 205. In one configuration, the intelligent remote touch approach may be referred to as remote access. The touch screen of the touch screen device 205 may be broken (as illustrated), may otherwise be prevented from being used or may be preferred not to be used. Diagram 200 illustrates the process of establishing remote access of the touch screen device 205 by a device 210 according to an aspect. At 220, the touch screen device 205 receives a command for activating remote access of the touch screen device 205. In an aspect, the command for activating remote access may be a pre-defined pattern of existing buttons being pressed (e.g., two or more of the power on/off button 104, the volume up button 106, the volume down button 108 being pushed concurrently and/or in sequence) on the touch screen device 205.

At 222, the touch screen device 205 sends a notification indicating the activation of the remote access feature of the touch screen device 205 to the device 210. In one configuration, the device 210 may be a computing device. In one configuration, the device 210 may be a portable device that has a working touch screen. In one configuration, the device 210 may be any computing device, with or without touch screen. In one configuration, the device 210 may be in the vicinity of the touch screen device 205. In such a configuration, the touch screen device 205 and the device 210 may communicate with each other using a short-range wireless communication protocol, such as Bluetooth, Wi-Fi, etc.

At 224, the device 210 may receive an authorization code locally (e.g., through input components of the device 210) for accessing the touch screen device 205 remotely. In one configuration, the authorization code may be received via the touch screen of the device 210.

At 226, the device 210 sends the authorization code to the touch screen device 205. In one configuration, the authorization code may be transmitted using a short-range wireless communication protocol, such as Bluetooth, Wi-Fi, etc. In one configuration, the authorization code may be transmitted using near-field communication (NFC). In one configuration, NFC based authorization may be used to ensure that the touch screen device 205 and the device 210 are in close proximity before the remote access feature can be enabled. Using NFC based authorization may reduce the chance of unauthorized remote access by ensuring the two devices are in close proximity, e.g., within inches of each other.

At 228, the touch screen device 205 may authorize remote access by the device 210 based on the received authorization code. In one configuration, the touch screen device 205 may compare the authorization code with a code stored in the touch screen device 205 and grant the remote access to the device 210 when the authorization code matches the stored code.

At 230, the touch screen device 205 may send an authorization (e.g., an confirmation of granting remote access) to the device 210. Upon reception of the authorization by the device 210, the remote access of the touch screen device 205 by the device 210 is enabled. In one configuration, the touch screen device 205 and the device 210 may be paired using a short-range wireless communication protocol (e.g., Bluetooth, Wi-Fi, etc.) in order to implement the remote access.

Diagram 250 describes operations performed after remote access of the touch screen device 205 by the device 210 has been enabled. At 252, the device 210 receives one or more commands for certain functions or applications as if the functions or applications are to be performed by the device 210. In one configuration, the one or more commands may be received through the touch screen of the device 210. In one configuration, the commands may include launching an application, a phone number to call, uplink voice signal, activation of a function, etc. In one configuration, Attention (AT)/Android commands or some other command set may be sent to the touch screen device 205 to be executed by the touch screen device 205. In such a configuration, existing OS commands are used such that no application needs to be stored on the device 210.

At 254, the device 210 may relay the commands received at 252 to the touch screen device 205 as remote commands for execution by the touch screen device 205. At 256, the touch screen device 205 may be operated based on execution of the remote commands. At 258, the touch screen device 205 may send application data (e.g., a downlink voice signal, screen data, contacts information, emails, or other files stored on the touch screen device 205, etc.) to the device 210.

In one configuration, the remote access feature of a touch screen device (e.g., the touch screen device 205) may be enabled when the device's battery charge falls below a certain threshold. Since the touch screen device's touch screen may consume a significant amount of power, turning off the touch screen and operating the touch screen device remotely using another device (e.g., the device 210) with ample battery capacity may extend the operating time of the touch screen device on battery power. Thus, the touch screen device's full functionality may be usable with minimum power consumption though the proposed remote touch approach.

In one configuration, a first user using a first phone (e.g., the device 210) may want to borrow a second phone (e.g., the touch screen device 205) from a second user to make a call, e.g., when the first phone reaches the maximum minutes allowed for the calling plan that the first phone subscribed to, or has no wireless coverage in a particular geographical area, etc. The second phone may or may not be a touch screen device. In such a configuration, the second phone (e.g., the touch screen device 205) may have the remote access feature enabled. The remote access feature may be enabled by providing the associated authorization code for the first phone. The first user may enter this authorization code to pair the first phone (e.g., the device 210) with the second phone (e.g., the touch screen device 205) to enable the remote access feature of the second phone. Once the pairing is done and the remote access feature is enabled, the first phone (e.g., the device 210) may be used to dial a number, the commands of which will be relayed to the second phone (e.g., the touch screen device 205) via a short-range wireless communication channel (e.g., Bluetooth, Wi-Fi, etc.) to establish a call using the radio capabilities of the second phone/device (e.g., the touch screen device 205). By allowing the first phone to access the second phone (e.g., the touch screen device 205) remotely, the second phone is not shared physically to enable the first phone to make a call via the second phone. Such an approach may provide increased security and privacy and may also avoid the inconvenience of physically borrowing the second phone. In one configuration, the remote access feature may be enable for one call, or for a predefined period of time, etc.

In one configuration, a user may forget the unlock passcode or pattern of a first phone (e.g., the touch screen device 205), or a kid in the family may enter wrong passcode multiple times while playing. The first phone may or may not be a touch screen device. Currently, if the user forgets the passcode of the first phone, there may be no way to operate and unlock the first phone until the first phone gets factory reset done by the vendor. Also, if a wrong password is entered multiple times in a row, the first phone may be locked until being unlocked by the vendor. In an aspect, the first phone (e.g., the touch screen device 205) may be paired with a second phone (e.g., the device 210) and operated without having to unlock the first phone. The remote access feature of the first phone may be enabled to allow the second phone to relay commands to the first phone, which operates based on the execution of the commands received from the second phone. Enabling the remote access feature of the first phone is helpful in enabling immediate access to the first phone before the first phone is fixed by the vendor. In one configuration, the first phone may be unlocked remotely using the remote access feature.

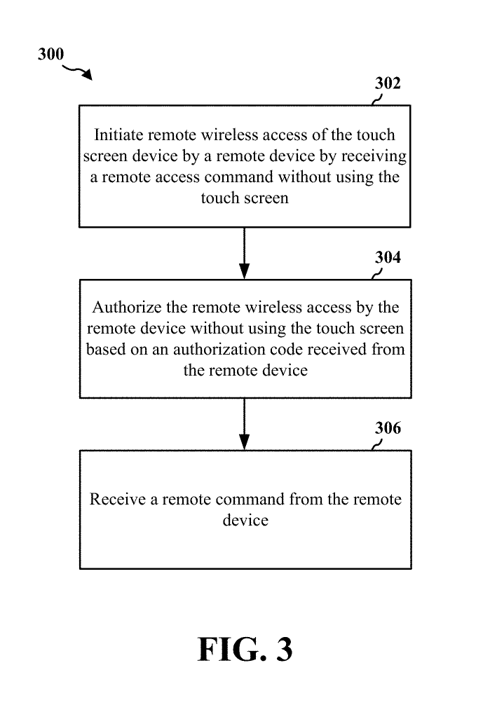

FIG. 3 is a flowchart 300 of a method of wireless remote touch. The method may be performed by a touch screen device (e.g., the touch screen device 100, 205, or the apparatus 502/502′). At 302, the touch screen device initiates remote wireless access of the touch screen device by a remote device (e.g., the device 210) by receiving a remote access command without using the touch screen of the device. In one configuration, the remote access command may include a pre-defined pattern of pressing a set of buttons of the device. The set of buttons may include one or more of the volume up button, the volume down button, or the power on/off button. In one configuration, the device may be a touch screen portable device. In one configuration, the remote wireless access may use a short-range wireless communication protocol (e.g., Bluetooth, Wi-Fi, etc.).

At 304, the touch screen device authorizes the remote wireless access by the remote device without using the touch screen of the device based on an authorization code received from the remote device. In one configuration, to authorize remote wireless access by the remote device, the touch screen device may receive wirelessly the authorization code from the remote device, compare the authorization code with a code stored on the touch screen device, and grant remote wireless access by the remote device when the authorization code matches the code stored on the touch screen device. In one configuration, to authorize remote wireless access by the remote device, the touch screen device may use NFC based authorization between the touch screen device and the remote device to grant the remote wireless access to the remote device. In one configuration, using NFC based authorization may ensure that the touch screen device and the remote device are in close proximity of each other, thus reducing the chance of unauthorized access. In one configuration, the touch screen device may pair with the remote device using a short-range wireless communication protocol.

At 306, the touch screen device may receive a remote command from the remote device. In one configuration, the remote device may receive a command via its input components and forward the received command to the touch screen device as the remote command. In one configuration, the touch screen device may execute the remote command.

In one configuration, the touch screen of the device may be damaged. In one configuration, a battery charge level of the device may be below a threshold. In one configuration, the remote command may be a phone number. In such a configuration, the touch screen device may make a call using the phone number, relay downlink voice signals to the remote device, and receive uplink voice signals from the remote device. The downlink voice signals may be received from a device that is identified by the phone number. The uplink voice signals may be generated by an application installed on the remote device. In one configuration, the device may be locked and inaccessible through the touch screen of the device.

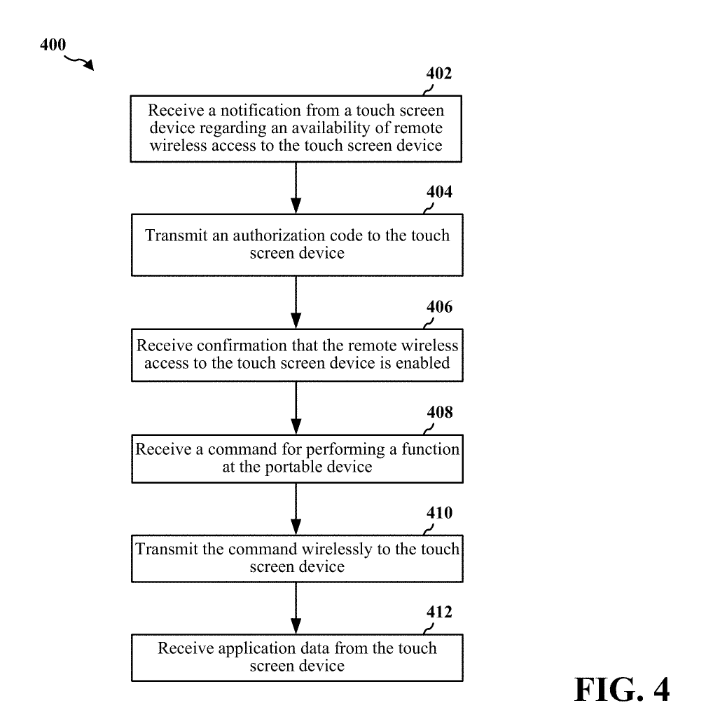

FIG. 4 is a flowchart 400 of a method of wireless remote touch. The method may be performed by a device (e.g., the device 210, or the apparatus 702/702′). In one configuration, the device may be a touch screen device. At 402, the device receives a notification from a touch screen device (e.g., the touch screen device 205) regarding the availability of remote wireless access to the touch screen device. In one configuration, the remote wireless access to the touch screen device may use a short-range wireless communication protocol (e.g., Bluetooth, Wi-Fi, etc.).

At 404, the device may transmit an authorization code to the touch screen device. In one configuration, the device may receive the authorization code (e.g., from user input).

At 406, the device may receive confirmation that remote wireless access to the touch screen device is enabled. In one configuration, to receive the notification, transmit the authorization code to the touch screen device, and receive confirmation that the remote wireless access to the touch screen device is enabled, the device may use NFC based authorization between the touch screen device and the device to grant the remote wireless access to the touch screen device.

At 408, the device may receive (e.g., by its touch screen) a command for performing a function at the device. In one configuration, the command be from the AT/Android commands, or some other command set.

At 410, the device may transmit the command wirelessly to the touch screen device.

At 412, the device may receive application data from the touch screen device. In one configuration, the command may be a phone number. In such a configuration, the device may further send an uplink voice signal to the touch screen device, and the application data may include a downlink voice signal. In one configuration, the device may pair with the touch screen device using a short-range wireless communication protocol. In one configuration, the application data may be received as a result of request for contact information stored on the touch screen device, request to read an email stored on the touch screen device, or request to access other data stored on the touch screen device, etc. In such a configuration, the request for information may be made by an application installed on the device to a corresponding application installed on the touch screen device, which retrieves the requested application data and sends the application data back to the application on the device.

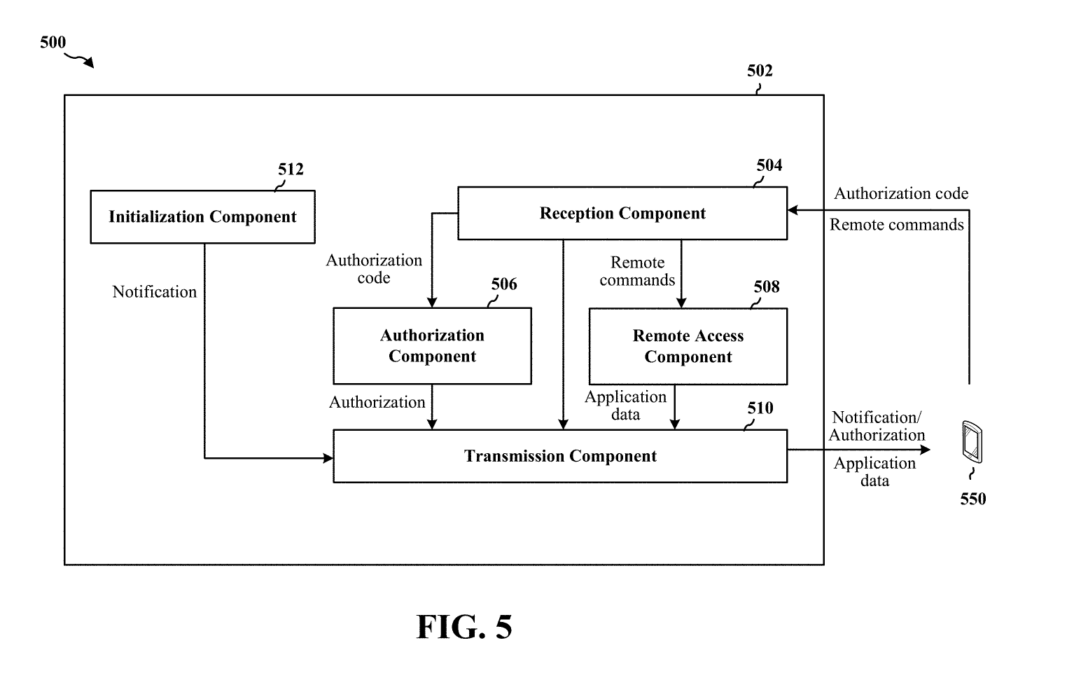

FIG. 5 is a conceptual data flow diagram 500 illustrating the data flow between different means/components in an exemplary apparatus 502. The apparatus 502 may be a touch screen device (e.g., the touch screen device 205). The apparatus 502 includes a reception component 504 that receives an authorization code for remote access and remote commands from a device 550. The apparatus 502 may include a transmission component 510 that transmits a notification that wireless access to the apparatus 502 is enabled, an authorization of remote wireless access by the device 550, and application data to the device 550. The reception component 504 and the transmission component 510 may cooperate to coordinate the communication of the apparatus 502.

The apparatus 502 may include an initialization component 512 that receive a command without using the touch screen of the apparatus 502 to turn on the remote wireless access of the apparatus 502. The initialization component 512 may send a notification to the transmission component to be sent to the device 550. In one configuration, the initialization component 512 may perform operations descried above with reference to 302 of FIG. 3.

The apparatus 502 may include an authorization component 506 that authorizes the device 550 for remote wireless access to the apparatus 502. In one configuration, the authorization component 506 may receive the authorization code from the reception component 504 and send the authorization to the transmission component 510 to be sent to the device 550. In one configuration, the authorization component 506 may perform operations descried above with reference to 304 of FIG. 3.

The apparatus 502 may include an remote access component 508 that operates based on commands received wirelessly from the device 550. In one configuration, the remote access component 508 may receive remote commands from the reception component 504 and send application data to the transmission component 510 to be sent to the device 550. In one configuration, the remote access component 508 may perform operations descried above with reference to 306 of FIG. 3.

The apparatus may include additional components that perform each of the blocks of the algorithm in the aforementioned flowchart of FIG. 3. As such, each block in the aforementioned flowchart of FIG. 3 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

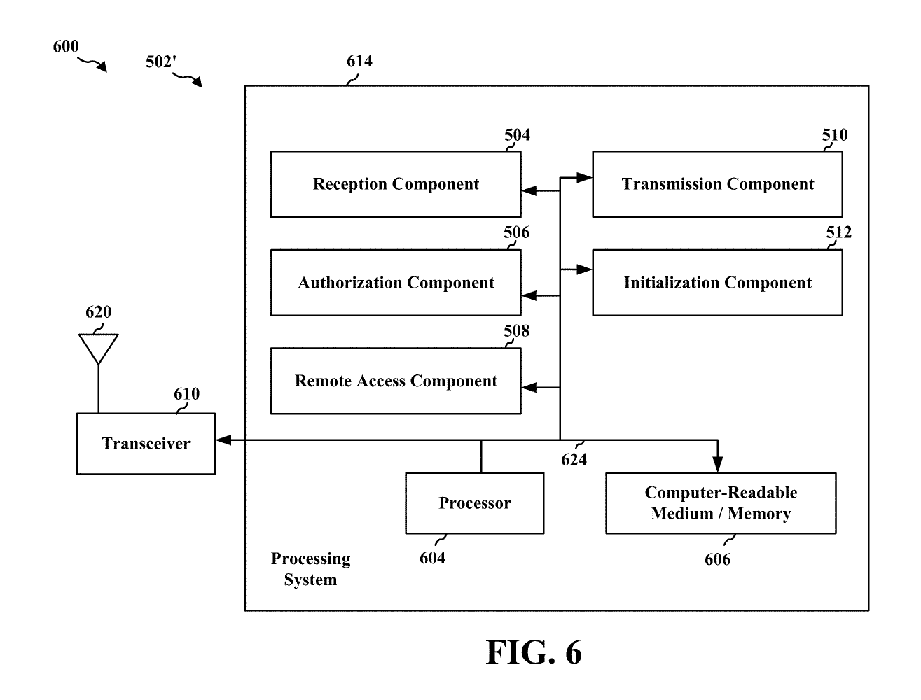

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor 604, the components 504, 506, 508, 510, 512, and the computer-readable medium/memory 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the reception component 504. In addition, the transceiver 610 receives information from the processing system 614, specifically the transmission component 510, and based on the received information, generates a signal to be applied to the one or more antennas 620. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the components 504, 506, 508, 510, 512. The components may be software components running in the processor 604, resident/stored in the computer readable medium/memory 606, one or more hardware components coupled to the processor 604, or some combination thereof.

In one configuration, the apparatus 502/502′ may include means for initiating remote wireless access of the apparatus by a remote device by receiving a remote access command without using the touch screen. In one configuration, the means for initiating remote wireless access of the apparatus by a remote device by receiving a remote access command without using the touch screen may perform operations described above with reference to 302 of FIG. 3. In one configuration, the means for initiating remote wireless access of the apparatus by a remote device by receiving a remote access command without using the touch screen may be the power on/off button 104, the volume up button 106, the volume down button 108, the initialization component 512, or the processor 604. In one configuration, the means for initiating remote wireless access may be configured to detect keystrokes, compares the detected keystrokes to a pre-defined pattern of keystrokes, and initiate remote access when a match is found between the detected keystrokes and the pre-defined pattern of keystrokes.

In one configuration, the apparatus 502/502′ may include means for authorizing remote wireless access by the remote device without using the touch screen based on an authorization code received from the remote device. In one configuration, the means for authorizing remote wireless access by the remote device without using the touch screen based on an authorization code received from the remote device may perform operations described above with reference to 304 of FIG. 3. In one configuration, the means for authorizing remote wireless access by the remote device without using the touch screen based on an authorization code received from the remote device may be the authorization component 506 or the processor 604.

In one configuration, the means for authorizing remote wireless access by the remote device without using the touch screen based on an authorization code received from the remote device may be configured to receive wirelessly the authorization code from the remote device, compare the authorization code with a code stored on the apparatus 502/502′, and grant the remote wireless access by the remote device when the authorization code matches the code stored on the apparatus 502/502′. In one configuration, the means for authorizing remote wireless access by the remote device without using the touch screen based on an authorization code received from the remote device may be configured to use NFC based authorization between the apparatus 502/502′ and the remote device to grant the remote wireless access to the remote device. In such a configuration, the means for authorizing remote wireless access may be an NFC component of the apparatus 502/502′.

In one configuration, the apparatus 502/502′ may include means for receiving a remote command from the remote device. In one configuration, the means for receiving a remote command from the remote device may perform operations described above with reference to 306 of FIG. 3. In one configuration, the means for receiving a remote command from the remote device may be the transceiver 610, the one or more antennas 620, the reception component 504, or the processor 604.

In one configuration, the apparatus 502/502′ may include means for executing the remote command. In one configuration, the means for executing the remote command may be the remote access component 508 or the processor 604. In one configuration, the apparatus 502/502′ may include means for making a call using a phone number and means for relaying downlink voice signals to the remote device and receiving uplink voice signals from the remote device. In one configuration, the apparatus 502/502′ may include means for reading an email, or means for retrieving a data file or a contact, etc.

In one configuration, the apparatus 502/502′ may include means for pairing with the remote device using a short-range wireless communication protocol. In one configuration, the means for pairing with the remote device using a short-range wireless communication protocol may be the transceiver 610, the one or more antennas 620, the reception component 504, the transmission component 510, the remote access component 508, or the processor 604.

The aforementioned means may be one or more of the aforementioned components of the apparatus 502 and/or the processing system 614 of the apparatus 502′ configured to perform the functions recited by the aforementioned means.

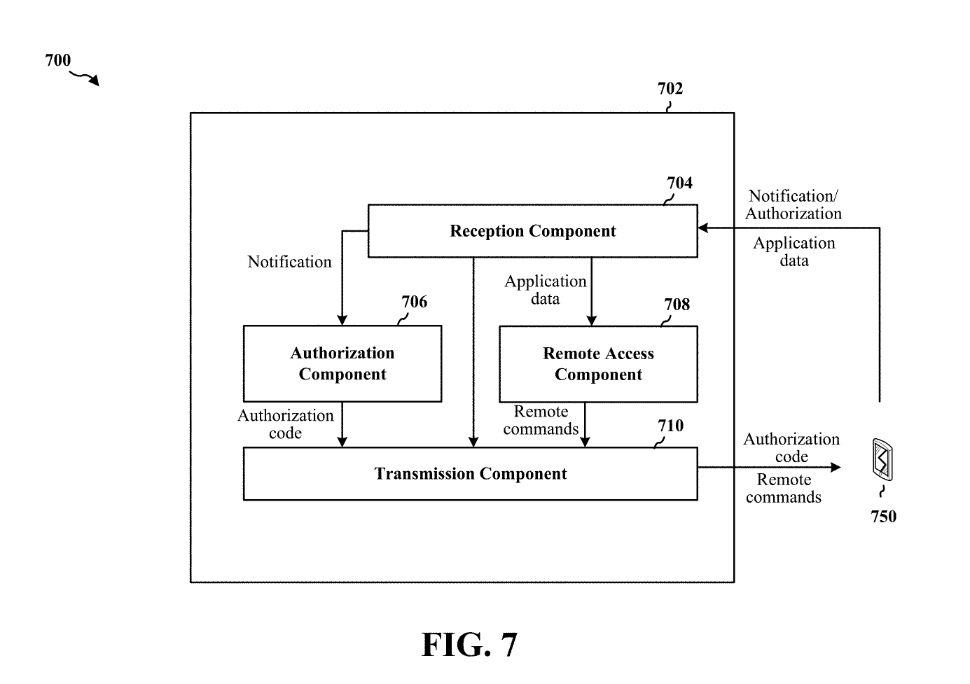

FIG. 7 is a conceptual data flow diagram 700 illustrating the data flow between different means/components in an exemplary apparatus 702. The apparatus may be a device (e.g., the device 210). The apparatus 702 includes a reception component 704 that receives a notification that wireless access to a touch screen device 750 is enabled, an authorization of remote wireless access by the touch screen device 750, and application data from the touch screen device 750. In one configuration, the touch screen device may have a broken touch screen. The apparatus 702 may include a transmission component 710 that transmits an authorization code for remote access and remote commands to the touch screen device 750. The reception component 704 and the transmission component 710 may cooperate to coordinate the communication of the apparatus 702.

The apparatus 702 may include an authorization component 706 that receives and transmits the authorization code to the transmission component to be transmitted to the touch screen device 750. In one configuration, the authorization component 706 may receive the notification that wireless access to the touch screen device 750 is enabled from the reception component 704. In one configuration, the authorization component 706 may perform operations descried above with reference to 402-406 of FIG. 4.

The apparatus 702 may include an remote access component 708 that receives and relays commands to the touch screen device 750. In one configuration, the remote access component 708 may receive application data from the reception component 704 and send remote commands to the transmission component 710 to be sent to the touch screen device 750. In one configuration, the remote access component 708 may perform operations descried above with reference to 408-412 of FIG. 4.

The apparatus may include additional components that perform each of the blocks of the algorithm in the aforementioned flowchart of FIG. 4. As such, each block in the aforementioned flowcharts of FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

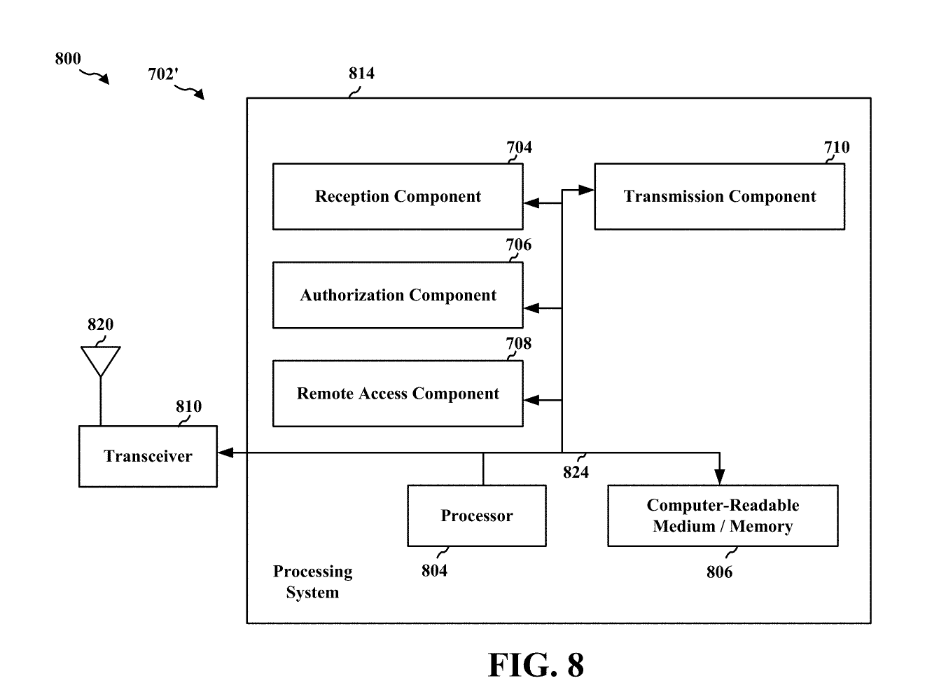

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710. The components may be software components running in the processor 804, resident/stored in the computer readable medium/memory 806, one or more hardware components coupled to the processor 804, or some combination thereof.

In one configuration, the apparatus 702/702′ includes means for receiving a notification from a touch screen device regarding an availability of remote wireless access to the touch screen device. In one configuration, the means for receiving a notification from a touch screen device regarding an availability of remote wireless access to the touch screen device may perform operations described above with reference to 402 of FIG. 4. In one configuration, the means for receiving a notification from a touch screen device regarding an availability of remote wireless access to the touch screen device may be the transceiver 810, the one or more antennas 820, the reception component 704, the authorization component 706, or the processor 804.

In one configuration, the apparatus 702/702′ includes means for receiving and transmitting an authorization code to the touch screen device. In one configuration, the means for receiving and transmitting an authorization code to the touch screen device may perform operations described above with reference to 404 of FIG. 4. In one configuration, the means for receiving and transmitting an authorization code to the touch screen device may be the touch screen, the transceiver 810, the one or more antennas 820, the transmission component 710, the authorization component 706, or the processor 804.

In one configuration, the apparatus 702/702′ includes means for receiving a confirmation that the remote wireless access to the touch screen device is enabled. In one configuration, the means for receiving a confirmation that the remote wireless access to the touch screen device is enabled may perform operations described above with reference to 406 of FIG. 4. In one configuration, the means for receiving a confirmation that the remote wireless access to the touch screen device is enabled may be the transceiver 810, the one or more antennas 820, the reception component 704, the authorization component 706, or the processor 804.

In one configuration, the apparatus 702/702′ includes means for receiving a command for performing a function at the device. In one configuration, the means for receiving a command for performing a function at the device may perform operations described above with reference to 408 of FIG. 4. In one configuration, the means for receiving a command for performing a function at the device may be the touch screen, the remote access component 708, or the processor 804.

In one configuration, the apparatus 702/702′ includes means for transmitting the command wirelessly to the touch screen device. In one configuration, the means for transmitting the command wirelessly to the touch screen device may perform operations described above with reference to 410 of FIG. 4. In one configuration, the means for transmitting the command wirelessly to the touch screen device may be the transceiver 810, the one or more antennas 820, the transmission component 710, the remote access component 708, or the processor 804.

In one configuration, the means for receiving the notification, the means for transmitting the authorization code to the touch screen device, and the means for receiving the confirmation that the remote wireless access to the touch screen device is enabled may be configured to use NFC based authorization between the touch screen device and the device to grant the remote wireless access to the touch screen device.

In one configuration, the apparatus 702/702′ includes means for sending an uplink voice signal to the touch screen device. In one configuration, the means for sending an uplink voice signal to the touch screen device may perform operations described above with reference to 410 of FIG. 4. In one configuration, the means for sending an uplink voice signal to the touch screen device may be the transceiver 810, the one or more antennas 820, the transmission component 710, the remote access component 708, or the processor 804.

In one configuration, the apparatus 702/702′ includes means for receiving a downlink voice signal from the touch screen device. In one configuration, the means for receiving a downlink voice signal from the touch screen device may perform operations described above with reference to 412 of FIG. 4. In one configuration, the means for receiving a downlink voice signal from the touch screen device may be the transceiver 810, the one or more antennas 820, the reception component 704, the remote access component 708, or the processor 804.

In one configuration, the apparatus 702/702′ may include means for pairing with the touch screen device using a short-range wireless communication protocol. In one configuration, the means for pairing with the touch screen device using a short-range wireless communication protocol may be the transceiver 810, the one or more antennas 820, the reception component 704, the transmission component 710, the remote access component 708, or the processor 804.

The aforementioned means may be one or more of the aforementioned components of the apparatus 702 and/or the processing system 814 of the apparatus 702′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of a device including a touch screen, comprising:
initiating remote wireless access of the device by a remote device by receiving a remote access command without using the touch screen;
authorizing the remote wireless access by the remote device without using the touch screen based on an authorization code received from the remote device; and
receiving a remote command from the remote device.

2. The method of claim 1, wherein the remote access command comprises a pre-defined pattern of pressing a set of buttons of the device.

3. The method of claim 2, wherein the set of buttons includes one or more of a volume up button, a volume down button, or a power on/off button.

4. The method of claim 1, wherein the authorizing the remote wireless access by the remote device comprises using a near field communication (NFC) based authorization between the device and the remote device to grant the remote wireless access to the remote device.

5. The method of claim 1, further comprising executing the remote command.

6. The method of claim 1, wherein the touch screen is damaged.

7. The method of claim 1, wherein a battery charge level of the device is below a threshold.

8. The method of claim 1, wherein the remote command is a phone number, the method further comprising:
making a call using the phone number;
relaying downlink voice signals to the remote device; and
receiving uplink voice signals from the remote device.

9. The method of claim 1, wherein the device is locked and is inaccessible through the touch screen.

10. An apparatus for wireless communication, the apparatus being a device including a touch screen, comprising:
means for initiating remote wireless access of the device by a remote device by receiving a remote access command at the apparatus without using the touch screen;
means for authorizing the remote wireless access by the remote device without using the touch screen based on an authorization code received from the remote device; and
means for receiving a remote command from the remote device.

11. The apparatus of claim 10, wherein the remote access command comprises a pre-defined pattern of pressing a set of buttons of the device.

12. The apparatus of claim 11, wherein the set of buttons includes one or more of a volume up button, a volume down button, or a power on/off button.

13. The apparatus of claim 10, wherein the means for authorizing the remote wireless access by the remote device is configured to use a near field communication (NFC) based authorization between the device and the remote device to grant the remote wireless access to the remote device.

14. The apparatus of claim 10, further comprising means for executing the remote command.

15. The apparatus of claim 10, wherein the touch screen is damaged.

16. The apparatus of claim 10, wherein a battery charge level of the device is below a threshold.

17. The apparatus of claim 10, wherein the remote command is a phone number, the apparatus further comprising:
means for making a call using the phone number; and
means for relaying downlink voice signals to the remote device and receiving uplink voice signals from the remote device.

18. The apparatus of claim 10, wherein the device is locked and is inaccessible through the touch screen.

19. An apparatus for wireless communication, the apparatus being a device including a touch screen, comprising:
a memory; and
at least one processor coupled to the memory and configured to:
initiate remote wireless access of the device by a remote device by receiving a remote access command without using the touch screen;
authorize the remote wireless access by the remote device without using the touch screen based on an authorization code received from the remote device; and
receive a remote command from the remote device.

20. The apparatus of claim 19, wherein the remote access command comprises a pre-defined pattern of pressing a set of buttons of the device.

21. The apparatus of claim 20, wherein the set of buttons includes one or more of a volume up button, a volume down button, or a power on/off button.

22. The apparatus of claim 19, wherein, to authorize the remote wireless access by the remote device, the at least one processor is configured to use a near field communication (NFC) based authorization between the device and the remote device to grant the remote wireless access to the remote device.

23. The apparatus of claim 19, wherein the at least one processor is further configured to execute the remote command.

24. The apparatus of claim 19, wherein the touch screen is damaged.

25. The apparatus of claim 19, wherein a battery charge level of the device is below a threshold.

26. The apparatus of claim 19, wherein the remote command is a phone number, wherein the at least one processor is configured to:
make a call using the phone number;
relay downlink voice signals to the remote device; and
receive uplink voice signals from the remote device.

27. The apparatus of claim 19, wherein the device is locked and is inaccessible through the touch screen.

28. A computer-readable medium storing computer executable code, comprising code to:
initiate remote wireless access of a device by a remote device by receiving a remote access command without using a touch screen of the device;
authorize the remote wireless access by the remote device without using the touch screen based on an authorization code received from the remote device; and
receive a remote command from the remote device.

29. The computer-readable medium of claim 28, wherein the remote access command comprises a pre-defined pattern of pressing a set of buttons of the device.

30. The computer-readable medium of claim 28, wherein the code to authorize the remote wireless access by the remote device is configured to use a near field communication (NFC) based authorization between the device and the remote device to grant the remote wireless access to the remote device.
